(19) United States
(12) Patent Application Publication
(10) Pub. No.: US 2018/0267569 A1
(43) Pub. Date: Sep. 20, 2018

(54) SMART WEARABLE DEVICE AND OPERATING METHOD

(71) Applicants: BOE TECHNOLOGY GROUP CO., LTD., Beijing (CN); BEIJING BOE MULTIMEDIA TECHNOLOGY CO., LTD., Beijing (CN)

(72) Inventors: Quanzhong Wang, Beijing (CN); Miao Liu, Beijing (CN); Hongna Ye, Beijing (CN)

(73) Assignees: BOE TECHNOLOGY GROUP CO., LTD., Beijing (CN); BEIJING BOE MULTIMEDIA TECHNOLOGY CO., LTD., Beijing (CN)

(21) Appl. No.: 15/762,209

(22) PCT Filed: Feb. 28, 2017
(86) PCT No.: PCT/CN2017/075088

§ 371 Date: Mar. 22, 2018

(30) Foreign Application Priority Data
May 23, 2016 (CN) 201610344703.5

(51) Int. Cl. G06F 1/16; G06Q 20/32; G06Q 20/36; G06Q 20/40; G06Q 20/06

(52) U.S. Cl. CPC G06F 1/163; G06Q 20/3227; G06Q 20/3278; G06Q 2220/00; G06Q 20/3678; G06Q 20/405; G06Q 20/0658; G06Q 20/3674

(57) ABSTRACT

In accordance with some embodiments of the disclosed subject matter, a smart wearable device, a related operating method, and a related operating apparatus are provided. In some embodiments, the smart wearable device comprises: a device shell; a central processor in the device shell; and a connector on the device shell configured for an external sensor to be inserted; wherein the central processor is connected with the connector and configured to control the external sensor to connect with the connector and to be turned on in response to an instruction to activate the external sensor.

### CROSS-REFERENCES TO RELATED APPLICATIONS

This application claims the priority of Chinese Patent Application No. 201610344703.5, filed on May 23, 2016, the entire content of which is incorporated herein by reference.

### FIELD OF THE DISCLOSURE

The present disclosure generally relates to the field of smart wearable device technology and, more particularly, relates to a smart wearable device and a related operating method.

### BACKGROUND

With the development of science and technology, more and more smart wearable products have entered into people's daily life. Taking a smart bracelet as an instance, a user can record real-time data of the daily life including exercise, sleep, diet, etc. through the smart bracelet. Further, the recorded data can be synchronized with a terminal device such as a mobile phone or a tablet. As such, the recorded data can be used to guide a healthy life. However, most of the current smart wearable devices have relatively simple and limited functions.

### BRIEF SUMMARY OF THE DISCLOSURE

In accordance with some embodiments of the disclosed subject matter, a smart wearable device, a related operating method are provided.

One aspect of present disclosure provides a smart wearable device, comprising: a device shell; a central processor in the device shell; and a connector on the device shell configured for an external sensor to be inserted; wherein the central processor is connected with the connector and configured to control the external sensor to connect with the connector and to be turned on in response to an instruction to activate the external sensor.

In some embodiments, the central processor includes a sensor recognition circuit, the sensor recognition circuit being configured to store a plurality of device IDs, and to recognize whether a device ID of the external sensor matches one of the plurality of device IDs.

In some embodiments, the sensor recognition circuit includes: a store unit configured to store the plurality of device IDs; a first receiving unit configured to receive the device ID of the external sensor that is inserted into the connector of the smart wearable device; and a first processing unit configured to, when the device ID of the external sensor matches one of the plurality of device IDs, and the instruction to activate the external sensor is received, control the external sensor to be turned on, and control the smart wearable device to present detection result information of the external sensor.

In some embodiments, the smart wearable device further comprises: a screen on the device shell; wherein the central processor is connected with the screen and configured to control the screen to display the detection result information of the external sensor.

In some embodiments, the smart wearable device further comprises: an electronic cash chip in the device shell; and a Near Field Communication (NFC) antenna; wherein the NFC antenna is connected to the electronic cash chip.

In some embodiments, the NFC antenna comprises a second receiving unit, and a transmitting unit, the second receiving unit is configured to receive amount deduction request information from a card reader and transmit the received amount deduction request information to the electronic cash chip; the electronic cash chip is configured to when the amount deduction request information matches a stored cipher text, subtract a corresponding credit payment amount from an account amount associated with the smart wearable device, and send an amount deduction confirmation information to the transmitting unit; and the transmitting unit is configured to transmit the amount deduction confirmation information to the card reader.

In some embodiments, the smart wearable device further comprises: a screen on the device shell; wherein the central processor is connected with the screen and the electronic cash chip, and is further configured to: control the screen to display a prompt message indicating a failure of credit payment when the amount deduction request information does not match the stored cipher text, and control the screen to display a prompt message indicating a success of credit payment when the amount deduction request information matches the stored cipher text.

In some embodiments, the smart wearable device further comprises: a vibration module in the device shell; wherein the central processor is connected to the vibration module, and is further configured to, when the amount deduction request information matches the stored cipher text, control the vibration module to generate a vibration.

In some embodiments, the connector includes following connection pins: SDA, SCL, INT, RST, GND, VCC, VBUS and ID; and the external sensor includes following connection pins: SDA, SCL, INT, RST, GND, VCC, VBUS and GND.

In some embodiments, the external sensor is one of: a heart rate sensor, a harmful gas sensor, and an air pressure sensor.

In some embodiments, the smart wearable device is one of a smart ring, a smart watch, or a smart wristband.

Another aspect of the present disclosure provides an operating method of a smart wearable device, comprising: receiving a device ID of an external sensor that is inserted into a connector of the smart wearable device; when the device ID of the external sensor matches one of a plurality of device IDs and an instruction to activate the external sensor is received, turning on the external sensor and controlling the smart wearable device to present detection result information of the external sensor.

In some embodiments, the operating method further comprises: when the device ID of the external sensor matches one of the plurality of device IDs, and an instruction to place the external sensor in a sleep mode is received, controlling the external sensor to enter the sleep mode, and controlling the smart wearable device to present a prompt message indicating that the external sensor is in the sleep mode.

In some embodiments, the operating method further comprises: when the device ID of the external sensor matches one of the plurality of device IDs, and an instruction to activate the external sensor has not been received within a preset period of time, controlling the external sensor to enter the sleep mode, and controlling the smart wearable device to present a prompt message indicating that the external sensor is in the sleep mode.

In some embodiments, the operating method further comprises: receiving amount deduction request information from a card reader; when the amount deduction request information matches a stored cipher text, subtracting a corresponding credit payment amount from an account amount associated with the smart wearable device; and transmitting an amount deduction confirmation to the card reader.

In some embodiments, the operating method further comprises: before subtracting the corresponding credit payment amount from an account amount, determining whether the amount deduction request information matches the stored cipher text, and determining whether the corresponding credit payment amount is within a preset credit payment limit range.

In some embodiments, the operating method further comprises: controlling the smart wearable device to present a prompt message indicating a failure of credit payment when the amount deduction request information does not match the stored cipher text.

In some embodiments, the operating method further comprises: controlling the smart wearable device to present a prompt message indicating a success of credit payment when the amount deduction request information matches the stored cipher text.

In some embodiments, the operating method further comprises: when the amount deduction request information matches the stored cipher text, controlling a vibration module of the smart wearable device to generate a vibration.

Another aspect of the present disclosure provides a smart wearable device, comprising: a device shell; a screen on the device shell; an electronic cash chip in the device shell; a central processor in the device shell and connected to the screen and the electronic cash chip; and a Near Field Communication (NFC) antenna connected to the electronic cash chip; wherein: the NFC antenna comprises a receiving unit, and a transmitting unit, the receiving unit is configured to receive amount deduction request information from a card reader and transmit the received amount deduction request information to the electronic cash chip; the electronic cash chip is configured to when the amount deduction request information matches a stored cipher text, subtract a corresponding credit payment amount from an account amount associated with the smart wearable device, and send an amount deduction confirmation information to the transmitting unit and the central processor; the transmitting unit is configured to transmit the amount deduction confirmation to the card reader; and the central processor is configured to control the screen to display a prompt message indicating a failure of credit payment when the amount deduction request information does not match the stored cipher text, and control the screen to display a prompt message indicating a success of credit payment when the amount deduction request information matches the stored cipher text.

Other aspects of the disclosed subject matter can be understood by those skilled in the art in light of the description, the claims, and the drawings of the present disclosure.

### BRIEF DESCRIPTION OF THE DRAWINGS

Various objectives, features, and advantages of the present disclosure can be more fully appreciated with reference to the detailed description of the present disclosure when considered in connection with the following drawings, in which like reference numerals identify like elements. It should be noted that the following drawings are merely examples for illustrative purposes according to various disclosed embodiments and are not intended to limit the scope of the present disclosure.

FIG. 1 illustrates a schematic structural view of an exemplary smart wearable device in accordance with some embodiments of the disclosed subject matter;

FIG. 2 illustrates a schematic connection diagram of a connector and pins of an external sensor in accordance with some embodiments of the disclosed subject matter;

FIG. 3 illustrates a schematic structural view of another exemplary smart wearable device in accordance with some other embodiments of the disclosed subject matter;

FIG. 4 illustrates an exploded schematic structural view of a smart wristwatch in accordance with some embodiments of the disclosed subject matter;

FIG. 5 illustrates a schematic flow chart of an exemplary operation method of a smart wearable device in accordance with some embodiments of the disclosed subject matter;

FIG. 6 illustrates a schematic flow chart of an exemplary operation method of a smart wearable device after an external sensor is inserted in accordance with embodiments of the disclosed subject matter;

FIG. 7 illustrates a schematic flow chart of an exemplary operation method of a smart wearable device for making a credit payment in accordance with some embodiments of the disclosed subject matter; and

FIG. 8 illustrates a schematic diagram of an exemplary operation apparatus of a smart wearable device in accordance with some embodiments of the disclosed subject matter.

### DETAILED DESCRIPTION

Reference input now be made in detail to exemplary embodiments of the invention, which are illustrated in the accompanying drawings in order to fully understand and being able to implementing the present disclosure and to realizing the technical effect. It should be understood that the following description has been made only by way of example, but not to limit the present disclosure. Various embodiments of the present disclosure and various features in the embodiments that are not conflicted with each other can be combined and rearranged in various ways. Without departing from the spirit and scope of the disclosed subject matter, modifications, equivalents, or improvements to the disclosed subject matter are understandable to those skilled in the art and are intended to be encompassed within the scope of the present disclosure.

In accordance with various embodiments, the present disclosure provides a smart wearable device and a related operating method.

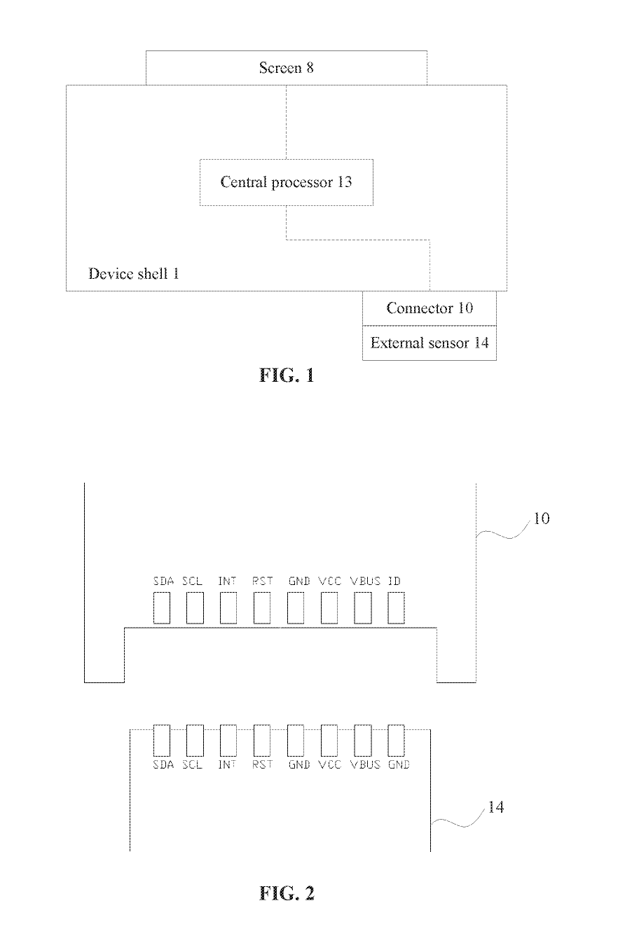

FIG. 1 illustrates a schematic structural view of an exemplary smart wearable device in accordance with some embodiments of the disclosed subject matter.

As illustrated, the smart wearable device can include a device shell 1, a central processor 13 in the device shell 1, a screen 8 on the device shell 1, and a connector 10 on the device shell 1 for connecting an inserted external sensor 14.

The central processor 13 can be connected to the screen 8 and the connector 10. If the external sensor 14 inserted in the connector 10 matches a pre-stored device ID, and in response to receiving an instruction from the user to activate the external sensor 14, the central processor 13 can control the external sensor 14 to start, and control the screen 8 to display detection result information of the external sensor 14.

In some embodiments of the present disclosure, the specific type of the smart wearable device is not limited. For example, the smart wearable device can be a smart watch, a smart wristband, a smart ring, etc. The specific type of the external sensor 14 that can be inserted into the connector 10 is also not limited. For example, the external sensor 14 can be a heart rate sensor, a harmful gas sensor, an air pressure sensor, etc.

In some embodiments, the smart wearable device may further include one or more internal sensors. For example, the smart wearable device may include a built-in motion sensor for detecting information about user's daily movements, including number of walking steps, sleep status, calorie consumption, etc. In some alternative embodiments, the heart rate sensor, the harmful gas sensor, and the air pressure sensor, etc., can also be integrated as one or more internal sensors of the smart wearable device.

In some embodiments, the central processor 13 can include build-in Bluetooth chips.

In some embodiments, when the external sensor 14 is inserted into the connector 10, the central processor 13 can determine whether an ID of the external sensor 14 matches the pre-stored device ID.

In some embodiments, a central processor of the smart wearable device can include a sensor recognition circuit. The sensor recognition circuit can be configured to store a plurality of device IDs, and to recognize whether a device ID of the external sensor matches one of the plurality of device IDs. The plurality of device IDs can include any suitable information to identify different external sensors and/or different types of external sensors. For example, each external sensor can be associated with a unique name or a unique code as the device ID of the external sensor.

When the determination result is positive, that is, when the device ID of the external sensor matches one of the plurality of device IDs, a “start” selection button and a “sleep” selection button can be displayed in the screen 8. When the user selects the “start” selection button, the central processor 13 can start up a power supply module (not shown in the figures) to supply the external sensor 14 and turn on the external sensor 14. When the determination result is negative, that is, when the ID of the external sensor 14 does not match any pre-stored device ID, a prompt message of “illegal device” can be displayed on the screen 8.

By using the above described technique, an adapted external sensor can be accessed to smart wearable device. By using the external sensors to achieve expanded functions, the functional applications of the smart wearable device can be enriched to bring convenience to users.

In some embodiments, when it is determined that the external sensor 14 matches the pre-stored device ID, and the user selects the “sleep” selection button, or an instruction to activate the external sensor 14 has not been received from the user within a preset period of time, the central processor 13 can control the external sensor 14 to enter a sleep mode, and can control the screen 8 to display a prompt message indicating that the external sensor 14 is in a sleep mode.

For example, the screen 8 can display a “start” selection button and a “sleep” selection button. When the user selects the “sleep” selection button or does not perform a selection operation within one minute, the central processor 13 can control the external sensor 14 to enter the sleep mode, and control the screen 8 to display a prompt message of “device is in a sleep mode.”

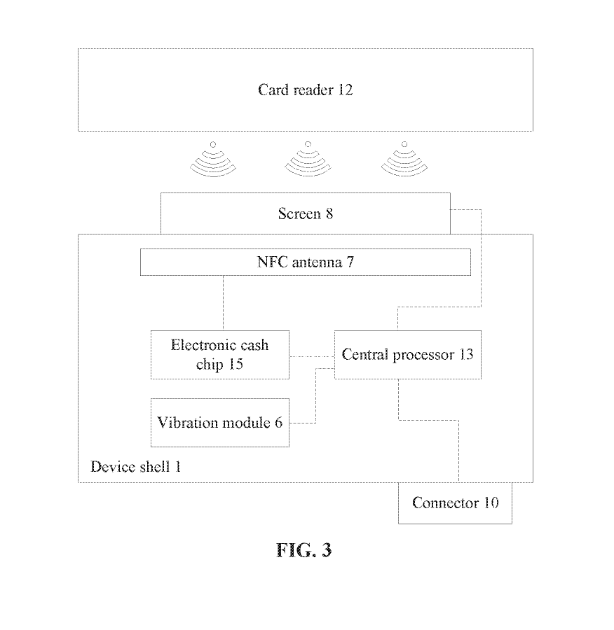

Referring to FIG. 2, a schematic connection diagram of a connector and pins of an external sensor is shown accordance with some embodiments of the disclosed subject matter.

The connector 10 can be a copper pillar connector with spring elements provided inside for reliable connection to the external sensor 14.

As illustrated in FIG. 2, the connection pins of the connector 10 can include SDA, SCL, INT, RST, GND, VCC, VBUS and ID. The connection pins of the external sensor 14 can include SDA, SCL, INT, RST, GND, VCC, VBUS and GND.

SDA and SCL are I²C interfaces which can be used for controlling the signal communication and data exchange between the smart wearable device and the external sensor 14. INT is an initialization signal interface. RST is a hardware reset interface. GND is a ground interface. VCC and VBUS can respectively support two-way power supply with different voltages between the smart wearable device and the external sensor 14.

ID interface is on the smart wearable device and is in a high voltage state. When the external sensor 14 is connected to the smart wearable device, the ID interface can be connected to the GND and be in a low voltage state. As such, the smart wearable device can recognize that the external sensor 14 is inserted, and can query specific device program through the I²C interfaces. If the specific device program satisfies a matching condition, which means that the external sensor 14 matches the pre-stored device ID, a driving program can be started to use the external sensor 14.

Referring to FIG. 3, a schematic structural view of another exemplary smart wearable device is shown in accordance with some ether embodiments of the disclosed subject matter.

As illustrated, in the device shell 1, the smart wearable device can further include an electronic cash chip 15 and a Near Field Communication (NFC) antenna 7.

The NFC antenna 7 can be connected to the electronic cash chip 15. The NFC antenna 7 can be used for receiving amount deduction request information from a card reader 12 and transmitting the received amount deduction request information to the electronic cash chip 15. The NFC antenna 7 can be further used for receiving amount deduction confirmation information from the electronic cash chip 15 and transmitting the received amount deduction confirmation information to the card reader 12. In some embodiments, the NFC antenna 7 can transmit information by using 13.56 GHz wireless signals.

The electronic cash chip 15 can be used for subtracting a corresponding credit amount from an account amount when the amount deduction request information matches a stored cipher text, and sending the amount deduction confirmation information to the NFC antenna 7.

Accordingly, in some embodiments of the present disclosure, an electronic cash chip 15 and an NFC antenna 7 can be provided in the smart wearable device. The electronic cash chip 15 can perform a payment operation when the amount deduction request information matches the stored cipher text, thereby can enrich the functional applications of the smart wearable device and facilitate the users.

For example, when a user carrying a disclosed smart wearable device takes a train, a subway, a bus, or other public transportation that need a card payment, instead of operations of taking a credit/transportation card out and swapping the credit/transportation card, the user can simply brush the smart wearable device against a card reader to make the payment, which is desirably convenient. In addition, compared to the traditional credit/transportation card payment, the use of cipher text checking method and other authentication methods can make the account for payment more secure.

In some embodiments, when the credit amount is within a preset credit payment limit range and the amount deduction request information matches the stored cipher text, the electronic cash chip 15 can be used for subtracting the corresponding credit amount from the account amount, and transmitting the amount deduction confirmation information to the NFC antenna 7.

For example, when the smart wearable device is used for making a transportation payment on a vehicle, the credit payment limit range set in the electronic cash chip 15 may be from 0 to 100 dollars. When the electronic cash chip 15 receives a credit payment amount of 1,000 dollars, it can be determined as a malicious payment, and the payment process can be terminated.

That is, when making an electronic credit payment through the disclosed smart wearable device, in addition to matching the amount deduction request information with the stored cipher text, the credit payment amount should be within the preset credit payment limit range. Therefore, the security of the account for payment can be further improved.

In some embodiments, the central processor 13 can be also connected to the electronic cash chip 15. When the amount deduction request information does not match the stored cipher text, the central processor 13 can control the screen 8 to display a prompt message indicating a failure of the credit payment. When the amount deduction request information matches the stored cipher text, the central processor 13 can control the screen 8 to display a prompt message indicating a success of the credit payment. In some embodiments, the prompt message indicating a success of the credit payment can include the amount of the credit payment and/or a balance of the account.

Accordingly, a user can easily use the disclosed smart wearable device to make payment, and can see the payment result from the screen of the smart wearable device. Therefore, the above described technique can further improve the convenience of payment.

In some embodiments, as illustrated in FIG. 3, the smart wearable device can further include a vibration module 6 disposed in the device shell 1 and connected to the central processor 13. When the amount deduction request information matches the stored cipher text, the central processor 13 can further control the vibration module 6 to generate vibration of the smart wearable device. As such, the user can obtain the credit payment result by feeling the vibration. Therefore, the convenience of payment can be further improved.

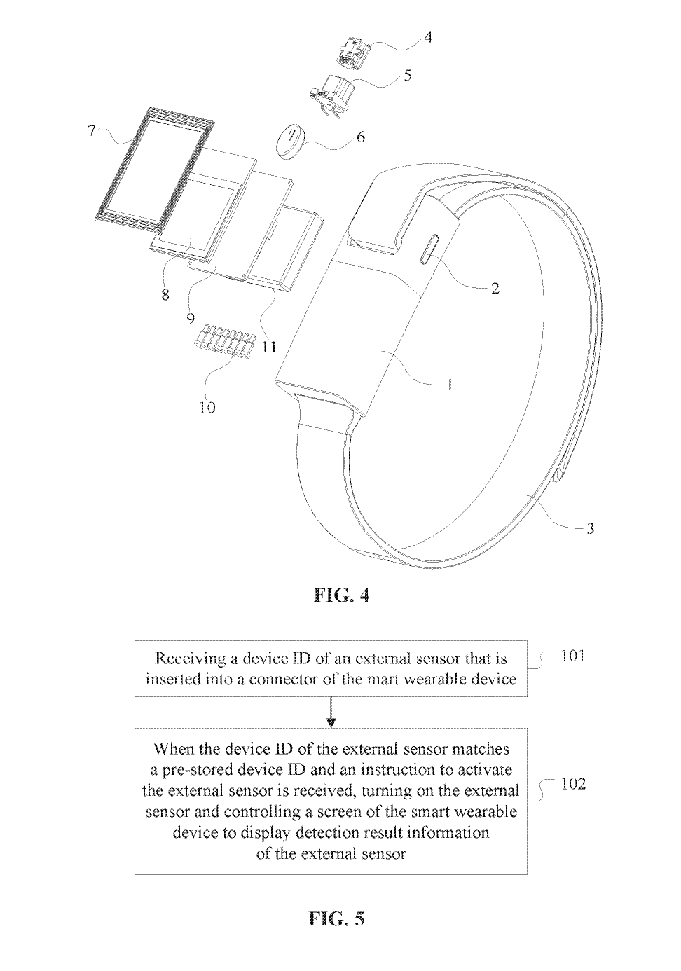

Referring to FIG. 4, an exploded schematic structural view of a smart wristwatch is shown in accordance with some embodiments of the disclosed subject matter.

As illustrated, the smart wristwatch can include a device shell 1, a physical button 2, a wristband 3, a USB interface 4, a USB waterproof protective cover 5, a circular vibrator which is the vibration module 6, an NFC antenna 7, a screen 8, a circuit board 9 including a central processor 13 and an electronic cash chip 15 provided on the circuit board 9, a connector 10, and a battery 11.

In summary, the smart wearable device provided by the above described embodiments of the present disclosure not only enriches the functional applications of the smart wearable device, but also brings more convenience to the user.

Referring to FIG. 5, a schematic flow chart of an exemplary operation method of an exemplary smart wearable device is shown in accordance with some embodiments of the disclosed subject matter. As illustrated, the operation method of the smart wearable device can include the following steps.

At step 101, a device ID of an external sensor that is inserted into a connector of the smart wearable device can be received.

At step 102, when the device ID of the external sensor matches a pre-stored device ID and an instruction to activate the external sensor is received from a user, the external sensor can be turned on, and a prompt message of a detection result of the external sensor can be displayed on a screen of the smart wearable device.

In some embodiments, the display of the prompt messages and/or data on the screen of the smart wearable device corresponding to the external sensors and the internal sensors may be distinguishable. Further, the display of the prompt messages and/or data on the screen of the smart wearable device may have different designs based on the types of the sensors.

For example, the prompt messages of detection results corresponding to different types of external sensors may be displayed by using different colors or different fonts. As another example, the prompt messages of detection results corresponding to different types of sensors may be displayed in different locations of the screen of the smart wearable device. As another example, the prompt messages of detection results corresponding to different types of sensors may be displayed in association with different audio/video representations.

In a specific example, if the inserted external sensor 14 is a heart rate sensor, and when a detection result of the heart rate sensor indicates a tachycardia, the smart wearable device may display a flash warning sign with a current heart rate in a red color, and may play a first voice alert simultaneously. As another specific example, if the inserted external sensor 14 is a harmful gas sensor, and when a detection result of the harmful gas sensor indicates a certain harmful gas, the smart wearable device may display a name of the harmful gas and a current harmful gas concentration in green color, and may play a second voice alert simultaneously.

In some embodiments, the operation method further dudes a step of when the device ID of the external sensor matches the pre-stored device ID, and an instruction to place the external sensor in a sleep mode is received, or an instruction to activate the external sensor has not been received from the user within a preset period of time, the external sensor can enter a sleep mode, and a prompt message indicating that the external sensor is in a sleep mode can be displayed on the screen of the smart wearable device.

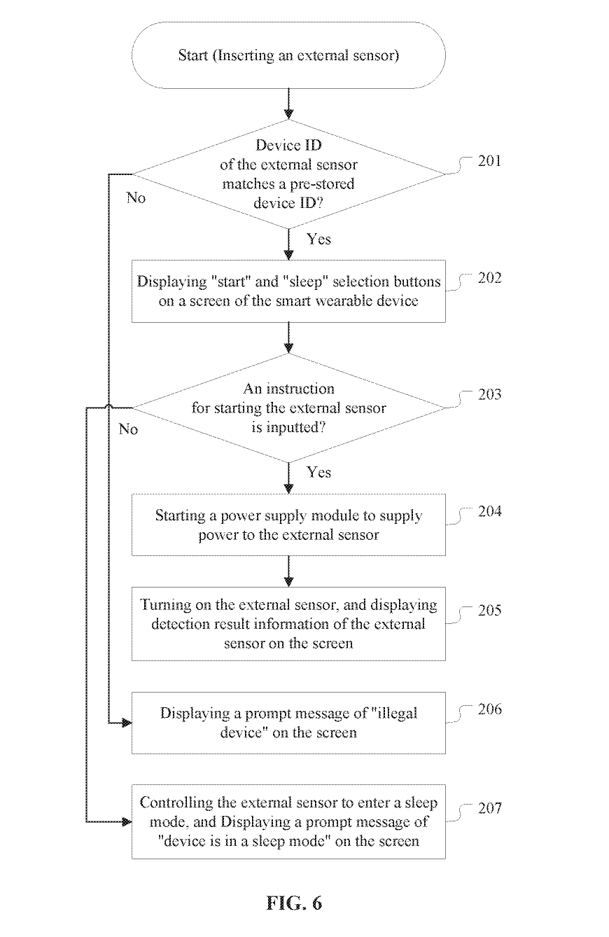

FIG. 6 illustrates a schematic flow chart of an exemplary operation method of a smart wearable device after an external sensor is inserted in accordance with some embodiments of the disclosed subject matter. As illustrated, the operation method of the smart wearable device can include the following steps.

At step 201, it can be determined whether a device ID of the external sensor matches a pre-stored device ID. If the determination result is positive, step 202 can be performed, otherwise, step 206 can be performed.

At step 202, a “start” selection button and a “sleep” selection button can be displayed on a screen of the smart wearable device.

At step 203, it can be determined that whether an instruction for starting the external sensor is inputted from a user. If the determination result is positive, step 204 can be performed, otherwise, step 207 can be performed.

At step 204, a power supply module can be started to supply power to the external sensor.

At step 205, the external sensor can be turned on, and a prompt message of a detection result of the external sensor can be displayed on the screen.

At step 206, a prompt message of “illegal device” can be displayed on the screen.

At step 207, the external sensor can be controlled to enter a sleep mode, and a prompt message of “device is sleeping” can be displayed on the screen.

In some embodiments, the operation method can further includes the following steps: receiving amount deduction request information from a card reader; when the amount deduction request information matches the stored cipher text, subtracting a corresponding credit payment amount from an account amount associated with the smart wearable device; and transmitting an amount deduction confirmation to the card reader.

In some embodiments, before subtracting the corresponding credit payment amount from an account amount, the operation method can further include determining whether the amount deduction request information matches the stored cipher text, and determining whether the corresponding credit payment amount is within a preset credit payment limit range.

In some embodiments, the operation method can further include displaying a prompt message indicating a failure of credit payment when the amount deduction request information does not match the stored cipher text, and displaying a prompt message indicating a success of credit payment when the amount deduction request information matches the stored cipher text.

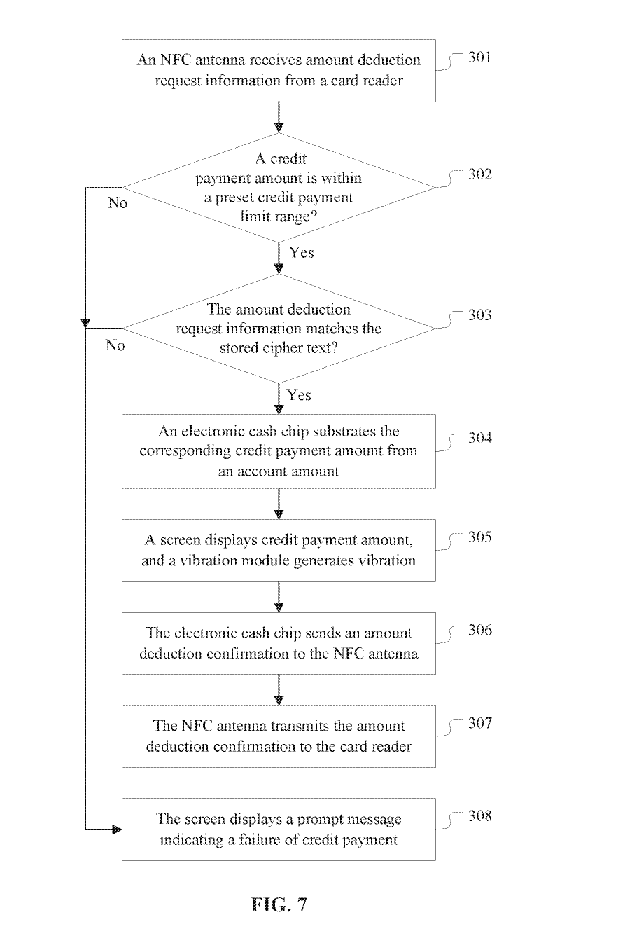

Referring to FIG. 7, a schematic flow chart of an exemplary operation method of a smart wearable device for making a credit payment is shown in accordance with some embodiments of the disclosed subject matter. As illustrated, the operation method of the smart wearable device can include the following steps.

At step 301, an NFC antenna of the smart wearable device can receive amount deduction request information from a card reader.

At step 302, an electronic cash chip of the smart wearable device can determine whether a credit payment amount corresponding to the amount deduction request information is within a preset credit payment limit range. If a result of the determination is positive, step 303 can be performed. Otherwise, step 308 can be performed.

At step 303, the electronic cash chip can determine whether the amount deduction request information matches the stored cipher text. If a result of the determination is positive, step 304 can be performed. Otherwise, step 308 can be performed.

At step 304, the electronic cash chip can substrate the corresponding credit payment amount from an account amount associated with the smart wearable device.

At step 305, the screen can display credit payment amount, and a vibration module of the smart wearable device can generate vibration to remind the user.

At step 306, the electronic cash chip can send amount deduction confirmation information to the NFC antenna.

At step 307, the NFC antenna can transmit the amount deduction confirmation information to the card reader.

At step 308, the screen can display a prompt message indicating a failure of the credit payment.

The executive order of step 305 and step 306 are not limited to the above-described executive sequence. For example, step 305 and step 306 can be performed simultaneously. As another example, step 306 can be performed before step 305 is performed.

In some embodiments, the prompt message indicating a failure or success of the credit payment may be displayed together with the prompt from an external sensor (e.g., a heart rate sensor) and an internal sensor (e.g., a motion sensor) on the screen. The smart wearable device may present data related to payment functions, data from internal sensors, and data from external sensors on the same screen or in an integrated user presentation.

Accordingly, in some embodiments of the present disclosure, the disclosed operation method of the smart wearable device can enrich the functional applications of the smart wearable device, facilitate the users, and improve security of the credit payment.

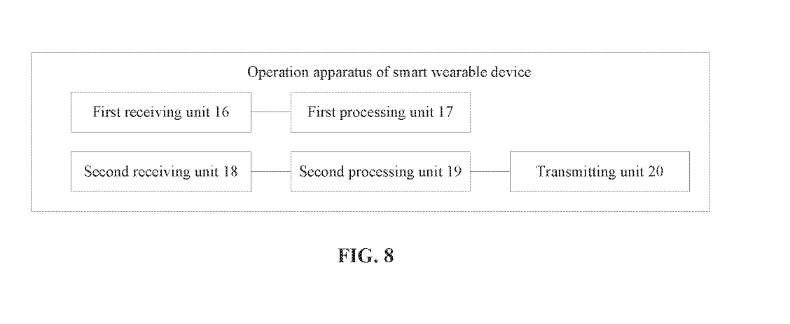

Referring to FIG. 8, a schematic diagram of an exemplary operation apparatus of a smart wearable device is shown in accordance with some embodiments of the disclosed subject matter. As illustrated, the operation apparatus of the smart wearable device can include the following components.

A first receiving unit 16 can be configured for receiving a device ID of an external sensor that is inserted into a connector of the smart wearable device.

A first processing unit 17 can be configured for, when the device ID of the external sensor matches a pre-stored device ID and an instruction to activate the external sensor is received from a user, controlling the external sensor to be turned on, and controlling a screen of the smart wearable device to display a prompt message of a detection result of the external sensor.

In some embodiments, the first processing unit 17 can be configured for, when the device of the external sensor matches the pre-stored device ID, and an instruction to place the external sensor in a sleep mode is received, or an instruction to activate the external sensor has not been received from the user within a preset period of time, controlling the external sensor to enter a sleep mode, and controlling the screen of the smart wearable device to display a prompt message indicating that the external sensor is in a sleep mode.

In some embodiments, the operation apparatus of the smart wearable device can further include the following components.

A second receiving unit 18 can be configured for receiving amount deduction request information from a card reader.

A second processing unit 19 can be configured for, when the amount deduction request information matches the stored cipher text, subtracting a corresponding credit payment amount from an account amount associated with the smart wearable device.

A transmitting unit 20 can be configured for transmitting an amount deduction confirmation to the card reader.

In some embodiments, the second processing unit 19 can be further configured for determining whether the amount deduction request information matches the stored cipher text, and determining whether the corresponding credit payment amount is within a preset credit payment limit range.

In some embodiments, the second processing unit 19 can be further configured for, when the amount deduction request information matches the stored cipher text, and the corresponding credit payment amount is within the preset credit payment limit range, subtracting the corresponding credit payment amount from the account amount associated with the smart wearable device.

In some embodiments, the second processing unit 19 can be further configured for controlling the screen to display a prompt message indicating a failure of credit payment when the amount deduction request information does not match the stored cipher text.

In some embodiments, the second processing unit 19 can be further configured for controlling the screen to display a prompt message indicating a success of credit payment when the amount deduction request information matches the stored cipher text.

In some embodiments, the second processing unit 19 can be further configured for, when the amount deduction request information matches the stored cipher text, controlling a vibration module of the smart wearable device to generate a vibration.

Accordingly, in some embodiments of the present disclosure, the disclosed operation apparatus of the smart wearable device can enrich the functional applications of the smart wearable device, facilitate the users, and improve security of the credit payment.

It should be noted that, the inserted external sensor can be any suitable sensors, including a heart rate sensor, a harmful gas sensor, an air pressure sensor, etc.

It also should be noted that, the above steps of the flow diagrams of FIGS. 5-7 can be executed or performed in any order or sequence not limited to the order and sequence shown and described in the figures. Also, some of the above steps of the flow diagrams of FIGS. 5-7 can be executed or performed substantially simultaneously where appropriate or in parallel to reduce latency and processing times. Furthermore, it should be noted that FIGS. 5-7 are provided as an example only. At least some of the steps shown in the figures may be performed in a different order than represented, performed concurrently, or altogether omitted.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Accordingly, a smart wearable device, a related operating method, and a related operating apparatus are provided.

The disclosed smart wearable device can comprises a device shell, a central processor in the device shell, and a connector on the device shell configured for an external sensor to be inserted. The central processor is connected with the connector and configured to control the external sensor to connect with the connector and to be turned on in response to an instruction to activate the external sensor.

In some embodiments, the central processor includes a sensor recognition circuit, the sensor recognition circuit being configured to store a plurality of device IDs, and to recognize whether a device ID of the external sensor matches one of the plurality of device IDs.

In some embodiments, the sensor recognition circuit includes: a store unit configured to store the plurality of device IDs; a first receiving unit configured to receive the device ID of the external sensor that is inserted into the connector of the smart wearable device; and a first processing unit configured to, when the device ID of the external sensor matches one of the plurality of device IDs, and the instruction to activate the external sensor is received, control the external sensor to be turned on, and control the smart wearable device to present detection result information of the external sensor.

In some embodiments, the smart wearable device further comprises: a screen on the device shell: wherein the central processor is connected with the screen and configured to control the screen to display the detection result information of the external sensor.

In some embodiments, the smart wearable device further comprises: an electronic cash chip in the device shell; and a Near Field Communication (NFC) antenna; wherein the NFC antenna is connected to the electronic cash chip.

In some embodiments, the NFC antenna comprises a second receiving unit, and a transmitting unit, the second receiving unit is configured to receive amount deduction request information from a card reader and transmit the received amount deduction request information to the electronic cash chip; the electronic cash chip is configured to when the amount deduction request information matches a stored cipher text, subtract a corresponding credit payment amount from an account amount associated with the smart wearable device, and send an amount deduction confirmation information to the transmitting unit; and the transmitting unit is configured to transmit the amount deduction confirmation to the card reader.

In some embodiments, the smart wearable device further comprises: a screen on the device shell; wherein the central processor is connected with the screen and the electronic cash chip, and is further configured to: control the screen to display a prompt message indicating a failure of credit payment when the amount deduction request information does not match the stored cipher text, and control the screen to display a prompt message indicating a success of credit payment when the amount deduction request information matches the stored cipher text.

In some embodiments, the smart wearable device further comprises: a vibration module in the device shell; wherein the central processor is connected to the vibration module, and is further configured to, when the amount deduction request information matches the stored cipher text, control the vibration module to generate a vibration.

In some embodiments, the connector includes following connection pins: SDA, SCL, INT, RST, GND, VCC, VBUS and ID; and the external sensor includes following connection pins: SDA, SCL, INT, RST, GND, VCC, VBUS and GND.

In some embodiments, the external sensor is one of: a heart rate sensor, a harmful gas sensor, and an air pressure sensor.

In some embodiments, the smart wearable device is one of a smart ring, a smart watch, or a smart wristband.

The disclosed operating method of a smart wearable device can comprises: receiving a device ID of an external sensor that is inserted into a connector of the smart wearable device; when the device ID of the external sensor matches a pre-stored device ID and an instruction to activate the external sensor is received, turning on the external sensor and controlling the smart wearable device to present detection result information of the external sensor.

In some embodiments, the operating method further comprises: when the device ID of the external sensor matches the pre-stored device ID, and an instruction to place the external sensor in a sleep mode is received, controlling the external sensor to enter the sleep mode, and controlling the smart wearable device to present a prompt message indicating that the external sensor is in the sleep mode.

In some embodiments, the operating method further comprises: when the device ID of the external sensor matches the pre-stored device ID, and an instruction to activate the external sensor has not been received within a preset period of time, controlling the external sensor to enter the sleep mode, and controlling the smart wearable device to present a prompt message indicating that the external sensor is in the sleep mode.

In some embodiments, the operating method further comprises: receiving amount deduction request information from a card reader; when the amount deduction request information matches a stored cipher text, subtracting a corresponding credit payment amount from an account amount associated with the smart wearable device; and transmitting an amount deduction confirmation to the card reader.

In some embodiments, the operating method further comprises: before subtracting the corresponding credit payment amount from an account amount, determining whether the amount deduction request information matches the stored cipher text, and determining whether the corresponding credit payment amount is within a preset credit payment limit range.

In some embodiments, the operating method further comprises: controlling the smart wearable device to present a prompt message indicating a failure of credit payment when the amount deduction request information does not match the stored cipher text.

In some embodiments, the operating method further comprises: controlling the smart wearable device to present a prompt message indicating a success of credit payment when the amount deduction request information matches the stored cipher text.

In some embodiments, the operating method further comprises: when the amount deduction request information matches the stored cipher text, controlling a vibration module of the smart wearable device to generate a vibration.

Although the disclosed subject matter has been described and illustrated in the foregoing illustrative embodiments, it is understood that the present disclosure has been made only by way of example, and that numerous changes in the details of embodiment of the disclosed subject matter can be made without departing from the spirit and scope of the disclosed subject matter, which is only limited by the claims which follow. Features of the disclosed embodiments can be combined and rearranged in various ways. Without departing from the spirit and scope of the disclosed subject matter, modifications, equivalents, or improvements to the disclosed subject matter are understandable to those skilled in the art and are intended to be encompassed within the scope of the present disclosure.

1. A smart wearable device, comprising:
a device shell;
a central processor in the device shell; and
a connector on the device shell configured for an external sensor to be inserted;
wherein the central processor is connected with the connector and configured to control the external sensor to connect with the connector and to be turned on in response to an instruction to activate the external sensor.

2. The smart wearable device of claim 1, wherein the central processor includes a sensor recognition circuit, the sensor recognition circuit being configured to store a plurality of device IDs, and to recognize whether a device ID of the external sensor matches one of the plurality of device IDs.

3. The smart wearable device of claim 2, wherein the sensor recognition circuit includes:
a store unit configured to store the plurality of IDs;
a first receiving unit configured to receive the device ID of the external sensor that is inserted into the connector of the smart wearable device; and
a first processing unit configured to, when the device ID of the external sensor matches one of the plurality of device IDs, and the instruction to activate the external sensor is received, control the external sensor to be turned on, and control the smart wearable device to present detection result information of the external sensor.

4. The smart wearable device of claim 3, further comprising:
a screen on the device shell;
wherein the central processor is connected with the screen and configured to control the screen to display the detection result information of the external sensor.

5. The smart wearable device of claim 1, further comprising:
an electronic cash chip in the device shell; and
a Near Field Communication (NFC) antenna;
wherein the NFC antenna is connected to the electronic cash chip.

6. The smart wearable device of claim 5, wherein:
the NFC antenna comprises a second receiving unit, and a transmitting unit,
the second receiving unit is configured to receive amount deduction request information from a card reader and transmit the received amount deduction request information to the electronic cash chip;
the electronic cash chip is configured to when the amount deduction request information matches a stored cipher text, subtract a corresponding credit payment amount from an account amount associated with the smart wearable device, and send an amount deduction confirmation information to the transmitting unit; and
the transmitting unit is configured to transmit the amount deduction confirmation information to the card reader.

7. The smart wearable device of claim 6, further comprising:
a screen on the device shell;
wherein the central processor is connected with the screen and the electronic cash chip, and is further configured to:
control the screen to display a prompt message indicating a failure of credit payment when the amount deduction request information does not match the stored cipher text, and
control the screen to display a prompt message indicating a success of credit payment when the amount deduction request information matches the stored cipher text.

8. The smart wearable device of claim 6, further comprising:
a vibration module in the device shell;
wherein the central processor is connected to the vibration module, and is further configured to, when the amount deduction request information matches the stored cipher text, control the vibration module to generate a vibration.

9. The smart wearable device of claim 1, wherein:
the connector includes following connection pins: SDA, SCL, INT, RST, GND, VCC, VBUS and ID; and
the external sensor includes following connection pins: SDA, SCL, INT, RST, GND, VCC, VBUS and GND.

10. The smart wearable device of claim 1, wherein the external sensor is one of: a heart rate sensor, a harmful gas sensor, and an air pressure sensor.

11. The smart wearable device of claim 1, wherein:
the smart wearable device is one of a smart ring, a smart watch, or a smart wristband.

12. An operating method of a smart wearable device, comprising:
receiving a device ID of an external sensor that is inserted into a connector of the smart wearable device;
when the device ID of the external sensor matches one of a plurality of device IDs and an instruction to activate the external sensor is received, turning on the external sensor and controlling the smart wearable device to present detection result information of the external sensor.

13. The operating method of claim 12, further comprising:
when the device ID of the external sensor matches one of the plurality of device IDs, and an instruction to place the external sensor in a sleep mode is received, controlling the external sensor to enter the sleep mode, and controlling the smart wearable device to present a prompt message indicating that the external sensor is in the sleep mode.

14. The operating method of claim 12, further comprising:
when the device ID of the external sensor matches one of the plurality of device IDs, and an instruction to activate the external sensor has not been received within a preset period of time, controlling the external sensor to enter the sleep mode, and controlling the smart wearable device to present a prompt message indicating that the external sensor is in the sleep mode.

15. The operating method of claim 12, further comprising:
receiving amount deduction request information from a card reader;
when the amount deduction request information matches a stored cipher text, subtracting a corresponding credit payment amount from an account amount associated with the smart wearable device; and
transmitting an amount deduction confirmation to the card reader.

16. The operating method of claim 15, further comprising:
before subtracting the corresponding credit payment amount from an account amount, determining whether the amount deduction request information matches the stored cipher text, and determining whether the corresponding credit payment amount is within a preset credit payment limit range.

17. The operating method of claim 15, further comprising:
controlling the smart wearable device to present a prompt message indicating a failure of credit payment when the amount deduction request information does not match the stored cipher text.

18. The operating method of claim 15, further comprising:
controlling the smart wearable device to present a prompt message indicating a success of credit payment when the amount deduction request information matches the stored cipher text.

19. The operating method of claim 15, further comprising:
when the amount deduction request information matches the stored cipher text, controlling a vibration module of the smart wearable device to generate a vibration.

20. A smart wearable device, comprising:
a device shell;
a screen on the device shell;
an electronic cash chip in the device shell;
a central processor in the device shell and connected to the screen and the electronic cash chip; and
a Near Field Communication (NFC) antenna connected to the electronic cash chip:
wherein:
the NFC antenna comprises a receiving unit, and a transmitting unit,
the receiving unit is configured to receive amount deduction request information from a card reader and transmit the received amount deduction request information to the electronic cash chip;
the electronic cash chip is configured to when the amount deduction request information matches a stored cipher text, subtract a corresponding credit payment amount from an account amount associated with the smart wearable device, and send an amount deduction confirmation information to the transmitting unit and the central processor;
the transmitting unit is configured to transmit the amount deduction confirmation to the card reader; and
the central processor is configured to control the screen to display a prompt message indicating a failure of credit payment when the amount deduction request information does not match the stored cipher text, and control the screen to display a prompt message indicating a success of credit payment when the amount deduction request information matches the stored cipher text.
